(19) United States
(12) Patent Application Publication
(10) Pub. No.: US 2024/0187230 A1
(43) Pub. Date: Jun. 6, 2024

(54) A LOW OVERHEAD METHOD AND ARCHITECTURE FOR SIDE-CHANNEL ATTACK RESISTANCE IN ELLIPTIC CURVE ARITHMETIC

(71) Applicant: PQSecure Technologies, LLC, Boca Raton, FL (US)

(72) Inventors: Brian C. Koziel, Plano, TX (US); Rami El Khatib, Boca Raton, FL (US); Abubakr Abdulgadir, Reston, VA (US)

(73) Assignee: PQSecure Technologies, LLC, Boca Raton, FL (US)

(21) Appl. No.: 17/799,819

(22) PCT Filed: Dec. 17, 2021
(86) PCT No.: PCT/US21/64242

§ 371 Date: Aug. 15, 2022

(51) Int. Cl. H04L 9/30; H04L 9/00

(52) U.S. Cl. CPC H04L 9/3073; H04L 9/002; H04L 2209/08

(57) ABSTRACT

A computer processing system that includes an elliptic curve computational unit in a computer processing device operably configured to perform an elliptic curve arithmetic operation with a sequence of field operations, receive an elliptic curve numerical input that includes at least one elliptic curve coefficient of an elliptic curve that is operably utilized in the elliptic curve arithmetic operation,
receive an elliptic curve coefficient randomization numerical input that is operably configured for use in the elliptic curve arithmetic operation, compute a new and substantially equivalent elliptic curve representation for the elliptic curve coefficient of the elliptic curve by performing a field operation with the elliptic curve numerical input and the elliptic curve coefficient randomization numerical input, and utilize the new and substantially equivalent elliptic curve representation in the sequence of field operations, and having an arithmetic output port operably configured to output a numerical result therefrom.

### FIELD OF THE INVENTION

The present invention relates to generally to systems and methods that include resistance against side-channel leakage as they compute elliptic curve arithmetic, particularly related to elliptic curve and isogeny-based cryptosystems.

### BACKGROUND OF THE INVENTION

Cryptography is a key backbone of processing systems by securing the communications between various hard mathematical problems. Specially crafted protocols prevent third parties from reading private messages, also achieving certain information security goals including data confidentiality, data integrity, authentication, and non-repudiation. These protocols consist of cryptosystems, which is any cryptographic algorithm needed to implement a particular security service. However, these foundational mathematical problems can be side-stepped when considering the inevitable leakage of internal information as a cryptosystem is implemented. Timing, errors, power, heat, and acoustics are all examples of side-channels that can be observed by an outside party hoping to gain an advantage in cracking a cryptosystem. The physical security of today's digital infrastructure is now a critical vulnerability as secret keys can be recovered by “listening” to a device's power or timing information.

Side-channel analysis uses unintended information leakage of a cryptosystem to recover secret information. Emissions such as heat, power, or timing cannot be prevented when an cryptosystem is implemented, but it can be mitigated and controlled such that side-channel analysis becomes exceedingly difficult and expensive. Side-channel countermeasures achieve this by increasing noise in these emissions or hiding leaky computations. One large area of cryptography is the use of elliptic curves for public-key cryptography applications, or those involving a private and public keypair. Elliptic curve arithmetic, especially a scalar point multiplication can be very expensive. As such, if this computation can leak internal information, it is necessary to devise countermeasures that reduce leakage at a low overhead. It is desirable that the countermeasure does not greatly impact performance, power, and area.

Therefore, a need exists to overcome the problems with the prior art as discussed above.

### SUMMARY OF THE INVENTION

The invention provides a system and method for efficiently adding side-channel resistance to cryptosystems utilizing elliptic curve arithmetic. By adding randomness to the elliptic curve arithmetic with simple constructions, a low overhead approach is achieved.

With the foregoing and other objects in view, there is provided, in accordance with the invention, a computer processing system with at least one elliptic curve computational unit in a computer processing device operably configured to perform an elliptic curve arithmetic operation with a sequence of field operations, receive an elliptic curve numerical input that includes at least one elliptic curve coefficient of an elliptic curve that is operably utilized in the elliptic curve arithmetic operation, receive an elliptic curve coefficient randomization numerical input that includes a numerical value that is operably configured for use in the elliptic curve arithmetic operation, compute at least one new and substantially equivalent elliptic curve representation for the at least one elliptic curve coefficient of the elliptic curve by performing at least one field operation with the elliptic curve numerical input and the elliptic curve coefficient randomization numerical input, and utilize the at least one new and substantially equivalent elliptic curve representation in the sequence of field operations. The system also includes an arithmetic output port that is operably configured to output at least one numerical result from the elliptic curve arithmetic operation.

In accordance with a further feature of the present invention, the at least one elliptic curve coefficient represents an elliptic curve of any of the following forms: Short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves.

In accordance with yet another feature of the present invention, the at least one elliptic curve computational unit is operably configured to receive an elliptic curve point numerical input that includes at least one elliptic curve point that is operably utilized in the elliptic curve arithmetic operation and the at least one elliptic curve point includes an additional projective point value operably utilized in the elliptic curve arithmetic operation.

In accordance with an exemplary feature of the present invention, the at least one elliptic curve point is represented using any of the following coordinates: projective coordinates, Kummer coordinates, inverted coordinates, extended coordinates, Jacobian coordinates, modified Jacobian coordinates, doubling Doche-Icart-Kohel coordinates, tripling Doche-Icart-Kohel coordinates, extended Hessian coordinates, projective Jacobi quartics coordinates, extended Jacobi quartics coordinates, projective Jacobi intersection coordinates, or extended Jacobi intersection coordinates.

In accordance with an additional feature of the present invention, the at least one elliptic curve computational unit is operably configured to receive an additional input that includes a scalar or numerical value that is operably utilized in the elliptic curve arithmetic operation.

In accordance with a further feature of the present invention, the elliptic curve computational unit is operably configured to perform at least one of the following elliptic curve arithmetic operations: point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, or elliptic curve hashing.

In accordance with another feature, an embodiment of the present invention includes a random number generator operably configured to generate the elliptic curve coefficient randomization numerical input.

In accordance with yet another feature of the present invention, the at least one numerical result from the elliptic curve arithmetic operation and from the arithmetic output port is operably configured for use in an elliptic curve cryptosystem, a pairing-based cryptosystem, or an isogeny-based cryptosystem.

In accordance with another feature, an embodiment of the present invention also includes the at least one elliptic curve computational unit is operably configured to compute the least one new and substantially equivalent elliptic curve representation by performing at least one field multiplication with the curve coefficient randomization numerical input.

Although the invention is illustrated and described herein as embodied in a computer processing systems and methods for randomizing elliptic curve arithmetic in cryptosystems, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting: but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of any processing chip. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an experimental Test Vector Leakage Assessment of a SIKE implementation's scalar point multiplication. The figure shows some leakage that could be used to mount a side-channel attack:

FIG. 2 is an experimental Test Vector Leakage Assessment of a SIKE implementation's scalar point multiplication with state-of-the-art side-channel countermeasures. The figure shows significantly less leakage than FIG. 1, but has some leakage when an elliptic curve coefficient is used in the elliptic curve arithmetic:

FIG. 3 is an experimental Test Vector Leakage Assessment of a SIKE implementation's scalar point multiplication with this invention's curve coefficient randomization technique. The figure shows that the leakage is now entirely kept within acceptable bounds:

FIG. 4 illustrates the state-of-the-art approach for computing elliptic curve arithmetic operations on a computer processing system. The elliptic curve computational unit resident on the computer processing system executes a series of field operations given the elliptic curve inputs, optional point inputs, and optional additional inputs to output the arithmetic outputs:

FIG. 5 illustrates an embodiment of this invention for computing elliptic curve arithmetic operations on a computer processing system with side-channel attack resistance. By including a curve coefficient randomization input and utilizing it in the elliptic curve arithmetic operation by transforming the elliptic curve representation, the side-channel leakage of the elliptic curve arithmetic is obfuscated:

FIG. 6 illustrates an embodiment of this invention for computing elliptic curve arithmetic operations on a computer processing system with side-channel attack resistance. This view of the invention adds a new point input that receives elliptic curve point information that is used in the elliptic curve arithmetic operation:

FIG. 7 illustrates an embodiment of this invention for computing elliptic curve arithmetic operations on a computer processing system with side-channel attack resistance. This view of the invention adds an additional input that receives a scalar or other numerical value that is used in the elliptic curve arithmetic operation: and

FIG. 8 illustrates a process-flow diagram depicting an exemplary computer-implemented method for adding side-channel attack resistance in elliptic curve arithmetic in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel method and architecture to add side-channel resistance in elliptic curve arithmetic. By cleverly changing the elliptic curve arithmetic's curve representation, a new input can add new randomness to cryptosystem implementations that reduces power leakage when observed using an oscilloscope.

A cryptosystem is an instantiation of a cryptographic algorithm to provide a security service such as encrypting a message or signing a digital signature. When implemented in the real-world, a cryptographic implementation will execute the cryptographic algorithm, but leak various side-channel information, most notably including power, timing, heat, and electromagnetic radiation information. When implemented naively, a malicious third-party can observe side-channel information and use side-channel analysis to gain an advantage in breaking the cryptosystem. As those in the art will appreciate, there are known side-channel attacks that utilize timing or power information to recover a cryptosystem's secret key.

Side-channel analysis observes the unintentional leakage of side-channel information. A variety of different tools can be used to observe such information. For instance, an oscilloscope can be connected to a device's power source to monitor power and timing information. Likewise, various temperature sensors can be placed on a device to record heat information. With enough precision, these devices can pinpoint critical information that is leaked. Such information is then used in conjunction with known side-channel analysis attacks to retrieve secure inputs such as a plaintext message or private key.

There are a variety of ways to protect against side-channel attacks. The impact of side-channel analysis can be mitigated by adding additional noise or obscuring the side-channel's leakage. Unfortunately, there is no way to remove an implementation's side-channels and provide complete protection. Instead, the goal of side-channel countermeasures and resilience is to greatly increase the difficulty and cost to mount such an attack.

Public-key cryptography is a branch of cryptography that uses a pair of private and public keys to achieve a wide variety of cryptographic goals. For instance, public key encryption will encrypt a message by using the intended party's public key, such that it is now only decryptable by party's private key, achieving data confidentiality. An additional example is digital signatures, which allow a party to digitally sign a message with their public key, asserting that this party wrote the message, that the message was not altered, and that they cannot deny the message back later. Any outside user can verify this digital signature and thus that the party signed it. Further examples of public key cryptography include, but are not limited to authenticated key exchange, public key encryption, and zero-knowledge proofs.

Elliptic curve cryptography is among the most popular family of public-key cryptography algorithms as it provides a wide variety of applications with fast performance and low communication overhead. Examples of elliptic curve cryptography include, but are not limited to, elliptic curve Diffie-Hellman key exchange (ECDH), elliptic curve digital signature algorithm (ECDSA), Edwards curve digital signature algorithm (EdDSA), and password authenticated key exchange by juggling for elliptic curves (ECJPAKE). Pairing-based cryptography is then an extension of elliptic curve cryptography that generally focuses on the use of pairings between elements of elliptic curves to accomplish a cryptographic goal, such as key agreement. Isogeny-based cryptography has emerged as a new quantum computer resistant alternative to elliptic curve cryptography. Rather than stick to one elliptic curve, isogeny-based cryptography focuses on hard problems related to isogenies, or mappings between elliptic curves. Examples of isogeny-based schemes include, but are not limited to, the supersingular isogeny Diffie-Hellman (SIDH) key exchange, commutative supersingular isogeny Diffie-Hellman (CSIDH) key exchange, the supersingular isogeny key encapsulation (SIKE) mechanism, and the short quaternion and isogeny signature (SQISign).

This invention shows a new method and architecture to add side-channel resistance to elliptic curve arithmetic with low overhead. Notably, there have already been a number of techniques introduced in the literature that feature side-channel protection at some overhead. When considering elliptic curve arithmetic, the most common computation to attack is the scalar point multiplication. Given an elliptic curve E with point P∈E and a scalar k, scalar point multiplication performs the computation Q=k·P, where Q∈E. In the many cryptosystems utilizing scalar point multiplication, it is normally considered infeasible to recover the scalar k given P and Q, which is known as the elliptic curve discrete logarithm problem. However, side-channel attacks have been very successful at retrieving k when the elliptic curve arithmetic is implemented without side-channel resistance.

The scalar point multiplication, Q=k·P, can be computed as a sequence of point addition operations, R=P+Q, and point doubling operations, R=2·P. The binary method of scalar point multiplication is to then iterate through each bit of a binary representation of k. Starting with Q=P and iterating from the most significant bit to the least significant bit, the binary method uses an accumulator point Q and performs a point doubling for each bit, Q=2·Q, and a point addition with P if the bit was ‘1’, Q=Q+P. With this binary method, an oscilloscope can analyze the power and timing information to detect when the conditional point addition was performed, to decode the secret scalar k and break the cryptosystem.

In order to prevent side-channel attacks, implementations must be designed to carefully protect against a number of side-channels. For the scalar point multiplication, some examples of countermeasures include scalar blinding, projective point randomization, and a random isomorphism. Each countermeasure provides a different level of security at a different cost. In general, known countermeasures attempt to only mask the scalar. State-of-the-art countermeasures do not protect against leakage of the elliptic curve identifying information, such as the elliptic curve coefficients.

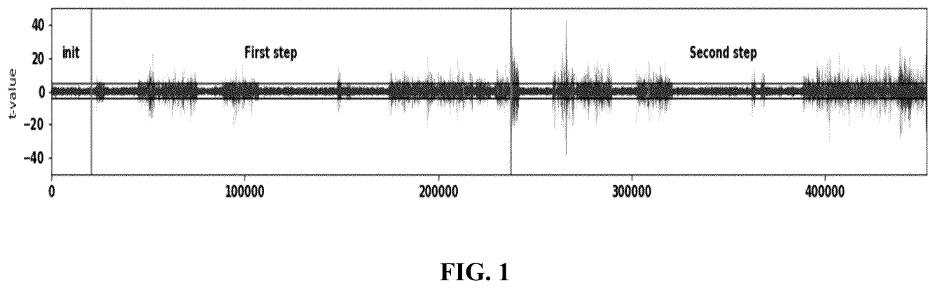

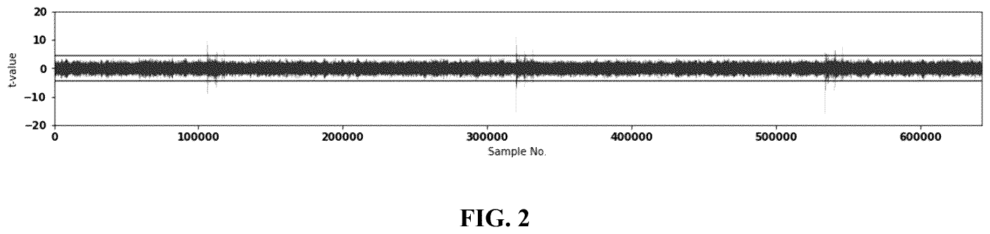

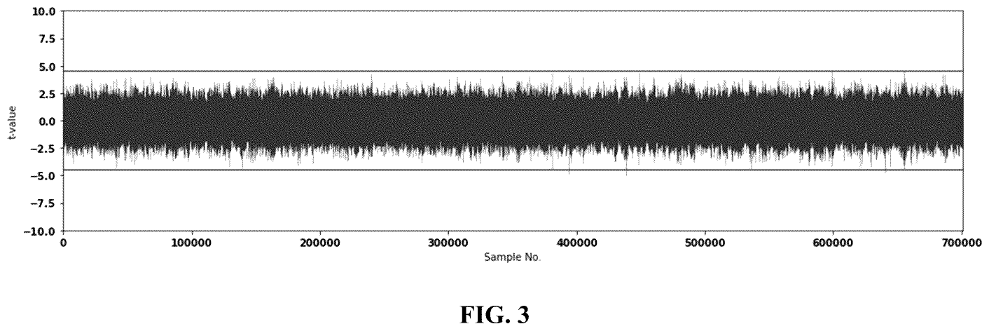

One method to analyze the resistance of an implementation is to use the Test Vector Leakage Assessment (TVLA) methodology. This methodology uses the Welch's T-test to detect any notable leakage over time. When examining the power leakage of a SIKE implementation on a Cortex-M4, there are noticeable spikes during a step of its implemented scalar point multiplication as is shown in FIG. 1. These spikes indicate some leakage that could be used to recover some internal information, potentially recovering the private key or shared secret used in SIKE. When implementing projective point randomization and scalar blinding on this same device, only a few spikes remained as is shown in FIG. 2. From further analysis, these countermeasures were not enough, so an additional countermeasure was needed for sufficient leakage suppression. The key insight was that multiplication by the elliptic curve's coefficient was causing leakage and required additional randomization. Thus, a novel curve coefficient randomization was introduced which now suppressed the TVLA results to be in an acceptable range, as is shown in FIG. 3.

The Short Weierstrass form of an elliptic curve is written as y²=x³+ax+b, where a and b are elliptic curve coefficients and this curve consists of all points (x, y) that satisfy this equation as well as the point at infinity. Based on the algebraic geometry of this curve, a point addition and point doubling formula can be found. Scalar point multiplication is then a sequence of addition and doubling. For cryptographic purposes, the number of points is limited by defining the elliptic curve over a large finite field. As this finite field becomes large, the elliptic curve discrete logarithm problem becomes extremely difficult for classical computers. With a large-scale quantum computer, it is believed that a quantum computer can utilize Shor's algorithm to break this problem.

In addition to masking the elliptic curve computation's side-channels, some applications may also attempt to mask the revealed elliptic curve. For instance, isogeny-based cryptography computes mappings between curves, for which a resulting curve may be kept secret. This invention provides a new low-cost method and architecture to protect cryptographic implementations involving elliptic curve arithmetic from side-channel leakage. The method introduces randomness in a new way that protects the elliptic curve information, such as the elliptic curve coefficients or curve cardinality.

Elliptic curves and their arithmetic can be defined in a multitude of ways, such as over the rational or complex numbers, a ring, or a finite field. Rational numbers and complex numbers are two examples of fields. Examples of finite fields include prime fields, binary fields, or prime extension fields. Finite fields are represented as the form pⁿ with characteristic p and dimension n. A prime field is a finite field of size p¹=p where each point or arithmetic can be represented with a single, large number that is reduced modulo a large prime. A binary field is a finite field of size 2ⁿ where each point or arithmetic can be represented with many bits. A prime extension field is a finite field of size pⁿ where each point or arithmetic can be represented with multiple large numbers that each reduced modulo a large prime.

Elliptic curve arithmetic includes any computations involving one or more elliptic curves as well as points on the one or more elliptic curves. Elliptic curve arithmetic includes, but is not limited to, point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, and elliptic curve hashing. Point addition adds two points to find a third point on an elliptic curve based on a geometric relationship. Point inversion involves finding a point's inverted representation on an elliptic curve. Point subtraction subtracts a point from another point to find a third point on an elliptic curve. Point subtraction can be performed by inverting the point to be subtracted and performing point addition with the other point. Point doubling adds a point with itself to find a second point on an elliptic curve based on a geometric relationship. Point halving finds half of a point by finding a new point that once doubled becomes the original point. Scalar point multiplication performs a series of point additions based on a scalar to find a new point on the elliptic curve. Point counting computes the total or subset number of points on an elliptic curve. Cardinality computations involves finding an elliptic curve's total number of points, which is its cardinality. Finding a generator point entails finding a point with a point order that matches the elliptic curve's cardinality. Finding a random point can use a variety of methods to pick a point that exists on the elliptic curve. Calculating point order involves finding the order of a point, where a scalar point multiplication will result in the point at infinity. The supersingularity of an elliptic curve can be checked in a variety of methods that show the elliptic curve has a large endomorphism ring. The Frobenius endomorphism is a special endomorphism of commutative rings with a prime characteristic. The j-invariant is a special identifier of an elliptic curve's isomorphism class, which can be found according to the elliptic curve geometry. An elliptic curve isomorphism computes a mapping between two elliptic curves that share the same j-invariant. An elliptic curve isogeny performs a non-constant rational map between two elliptic curves that have different j-invariants. An elliptic curve pairing is a bilinear map from two elements of one group to an element from a second group. Examples of elliptic curve pairings include, but are not limited to the Weil pairing, the Tate pairing, and the Ate pairing. Elliptic curve hashing performs a hash operation on an elliptic curve or point to find a hash digest.

In general, elliptic curve arithmetic is found and highly optimized according to the elliptic curve form. Additional forms of elliptic curves exist with various benefits or drawbacks. Examples of elliptic curve forms include, but is not limited to, short Weierstrass curves {y²=x³+ax+b}, Montgomery curves {by²=x³+ax²+x}, Edwards curves {x²+y²=c²·(1+d·x²·y²)}, twisted Edwards curves {a·x²+y²⁼¹+d·x²·y²}, Hessian curves {x³+y³+1=3·d·x·y}, twisted Hessian curves {a·x³+y³+1=d·x·y}, doubling-oriented Doche-Icart-Kohel curves {y²=x³+a·x²+16·a·x}, tripling-oriented Doche-Icart-Kohel curves {y²=x³+3·a·(x+1)²}, Jacobi intersections {s²+c²=1, a·s²+d²=1}, Jacobi quartics {y²=x⁴+2·a·x²⁺¹}, binary Edwards curves {d₁·(x+y)+d₂(x²+y²)=(x+x²)·(y+y²)}, binary Hessian curves {x³+y³+1=3·d·x·y}, and binary short Weierstrass curves {y²+x·y=x³+a₂x²+a₆}. For instance, Montgomery curves allow for a fast scalar point multiplication using the Montgomery ladder and Edwards curves offer unified and complete point addition formulas.

Furthermore, a point on an elliptic curve can be represented in many different ways, allowing for various benefits and draw backs. Projective point representations are one example as it changes the affine representation {(x, y)} to use an additional coordinate Z for the new projective point representation {(X: Y: Z)} where x=X/Z and y=Y/Z. By including this additional coordinate, a scalar point multiplication can be performed with only a single inversion operation, rather than an inversion operation for each point addition and point doubling. Examples of point representations include, but are not limited to, projective coordinates {(X: Y: Z), with x=X/Z and y=Y/Z}, Kummer coordinates {(X: Z), with x=X/Z}, inverted coordinates {(X: Y: Z), with x=Z/X and y=Z/Y}, extended coordinates {(X: Y: Z: T), with x=X/Z and y=Y/Z, and x·y=T/Z}, Jacobian coordinates {(X: Y: Z), with x=X/Z² and y=Y/Z³}, modified Jacobian coordinates {(X: Y: Z: T), with x=X/Z², y=Y/Z³, and T=a·Z⁴}, doubling Doche-Icart-Kohel coordinates {(X: Y: Z: ZZ), with x=X/Z, y=Y/ZZ, and ZZ=Z²}, tripling Doche-Icart-Kohel coordinates {(X: Y: Z: ZZ), with x=X/Z², y=Y/Z³, and ZZ=Z²}, extended Hessian coordinates {(X: Y: Z: XX: YY: ZZ: XY: YZ: X/Z), with x=X/Z, y=Y/Z, XX=X², YY=Y², ZZ=Z², XY=2·X·Y, X/Z=2·X·Z, and YZ=2·Y·Z}, projective Jacobi quartics coordinates {(X: Y: Z: XX: ZZ), with x=X/Z, y=Y/ZZ, XX=X², and ZZ=Z²}, extended Jacobi quartics coordinates {(X: Y: Z: XX: ZZ: R), with x=X/Z, y=Y/ZZ, XX=X², ZZ=Z², and R=2·X·Z}, projective Jacobi intersection coordinates {(S: C: D: Z), with s=S/Z, c=C/Z, d=D/Z}, and extended Jacobi intersection coordinates {(S: C: D: Z: SC: DZ), with s=S/Z, c=C/Z, d=D/Z, SC=S·C, DZ=D·Z}. Each of these point representations introduce one or more projective point values, which is typically represented by “Z” to achieve a performance or overhead advantage in an elliptic curve arithmetic operation.

To better explain the invention, Montgomery curves will be used as an example. A Montgomery curve can be represented in the Montgomery form by²=x³+ax²+x. Similar to the short Weierstrass form, a and b are defined over a finite field and this curve consists of all (x, y) that satisfy this equation as well as the point at infinity. When performing scalar point multiplication, Montgomery curves can take advantage of their Kummer coordinate form (X, Z), where x=X/Z. Note that the y-coordinate is not needed. Then, the fast Montgomery powering ladder is used to compute a scalar point multiplication by performing a differential point addition and point doubling for each bit in the scalar. The Montgomery powering ladder requires the curve constant a₂₄=(a+2)/4. The differential addition and doubling formula used for a step of the Montgomery ladder is shown below.

Algorithm 1: Montgomery Ladder Step (State-of-the-art)

Input: Montgomery curve E: by² = x³ + ax² + x, a₂₄ = (a + 2)/4, points P, Q, P − Q ∈ E, and P =
(PX : PZ), Q = (QX : QZ), P − Q = (PQX : PQZ).
Output: R₀, R₁ ∈ E, where R₀ = 2 · P and R₁ = P + Q
Begin
1. R₀.X = (PX − PZ)² · (PX + PZ)²
2. R₀.Z = ((PX + PZ)² − (PX − PZ))² · ((PX + PZ)² + a₂₄ · ((PX + PZ)² − (PX − PZ)²))
3. R₁.X = ((PX − PZ) · (QX + QZ) + (PX + PZ) · (QX − QZ))² · PQZ
4. R₁.Z = ((PX − PZ) · (QX + QZ) − (PX + PZ) · (QX − QZ))² · PQX
5. return R₀ = 2 · P and R₁ = P + Q
end

The new side-channel countermeasure is changing computations involving the curve coefficients by using a new representation for @24, which is identifying information of the elliptic curve. Instead of using a₂₄, the Montgomery powering ladder now uses a new elliptic curve representation A₂₄=a₂₄·C. With both A₂₄ and C, this new elliptic curve representation is substantially equivalent to the @24 elliptic curve representation as it can be easily recovered by performing a₂₄=A₂₄/C. The final representation of the resulting point is slightly changed, but equivalent as x=X/Z. The change in resulting X or Z is proportional so the resulting x-coordinate is the same.

Algorithm 2: Montgomery Ladder Step with elliptic curve side-channel countermeasure

Input: Montgomery curve E: by² = x³ + ax² + x, a₂₄ = (a + 2)/4, points P, Q, P − Q ∈ E, and P =
(PX : PZ), Q = (QX : QZ), P − Q = (PQX : PQZ), and curve randomization input C ≠ 0.
Output: R₀, R₁ ∈ E, where R₀ = 2 · P and R₁ = P + Q
Begin
1. A₂₄ = a₂₄ · C
2. R₀.X = (PX − PZ)² · C · (PX + PZ)²
3. R₀.Z = ((PX + PZ)² − (PX − PZ))² · (C · (PX + PZ)² + A₂₄ · ((PX + PZ)² − (PX − PZ)²))
4. R₁.X = ((PX − PZ) · (QX + QZ) + (PX + PZ) · (QX − QZ))² · PQZ
5. R₁.Z = ((PX − PZ) · (QX + QZ) − (PX + PZ) · (QX − QZ))² · PQX
6. return R₀ = 2 · P and R₁ = P + Q
end

As is shown above, the differential addition and doubling formula now includes an additional field multiplication. Field multiplications are typically much more expensive than field. Considering that there were previously 11 field multiplications in the state-of-the-art optimized explicit formulas, this increases the cost of scalar point multiplication by 2 field multiplications for about 18% computational overhead. If Step 1 is only performed once for many Montgomery ladder step operations, then there is only about a 9% overhead.

With C as a new input to elliptic curve arithmetic, revised elliptic curve formulas provide a way to mask the computations involving elliptic curve coefficients. If the elliptic curve is a secret, then this additional operation effectively adds side-channel attack resistance. As is shown in Algorithm 2, the Kummer representation of point R₀ now has a dependence on C. However, this value of (′ is propagated to both the R₀·X and R₀·Z, so the final R₀·x=R₀·X/R₀·Z will be the same. Thus, the revised formulas still hold. Similar adjustments can be applied to computations involving any elliptic curve form including, but not limited to, short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, and binary short Weierstrass curves.

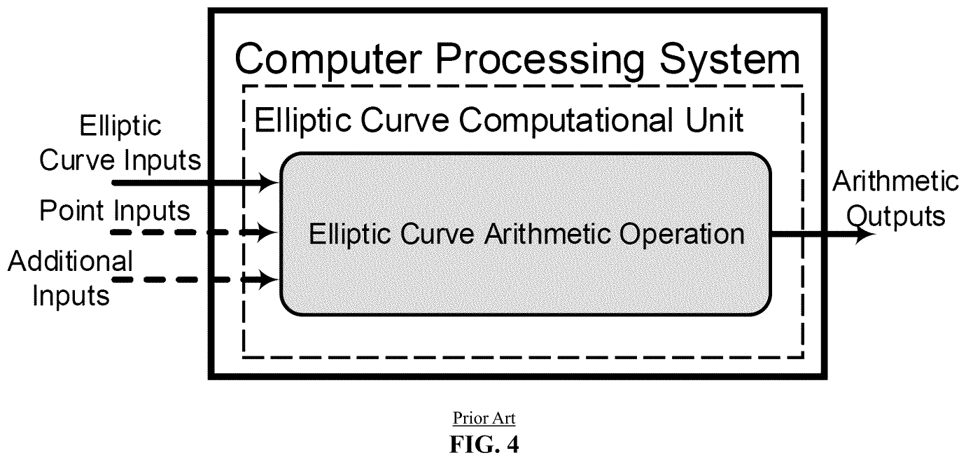

This invention provides a low overhead method to provide side-channel attack resistance to elliptic curve arithmetic. The state-of-the-art and prior-art method to perform elliptic curve arithmetic within a computer processing system is shown in FIG. 4. Within the computer processing system exists an elliptic curve computational unit that is operably configured to perform an elliptic curve arithmetic operation. This operation may consist of a sequence of field arithmetic that that is performed as part of a software processor or hardware circuit. As an input, the elliptic curve arithmetic operation requires at least one elliptic curve numerical input, and optionally at least one elliptic curve point numerical input or other numerical inputs. An example of an additional input could be, but is not limited to, a scalar that could be used in a scalar point multiplication or a non-constant rational map that could be used in an isogeny computation. Given this information, the elliptic curve arithmetic operation is performed, and the results are outputted.

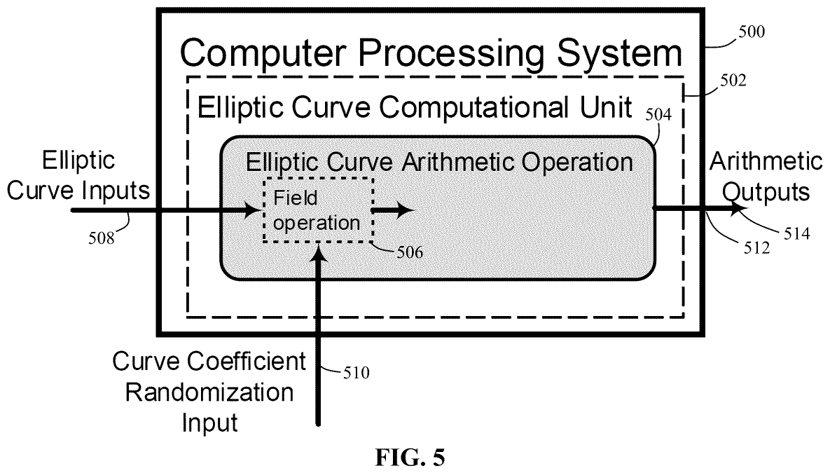

The primary embodiment of this invention is to include a new elliptic curve coefficient randomization input that can be used to mask computations with elliptic curve identifying information. For instance, scaling the elliptic curve coefficients with the curve coefficient randomization input will alter how the elliptic curve arithmetic operation is performed, to provide side-channel attack resistance with low overhead. As is shown in FIG. 5, this invention utilizes the elliptic curve coefficient randomization input to compute at least one new and substantially equivalent elliptic curve representation which is then used in the elliptic curve arithmetic's sequence of operations. This new and substantially equivalent elliptic curve can be used with a revised formula for an elliptic curve arithmetic operation to perform an equivalent result. This elliptic curve numerical input can represent any form of elliptic curve, which could be any of the following: Short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves.

Said another way, FIG. 5 depicts a computer processing system 500 with one or more elliptic curve computational unit(s) 502 in a computer processing device operably configured to perform an elliptic curve arithmetic operation 504 with a sequence of field operation(s) 506 and receive one or more elliptic curve numerical input(s) 508 that includes at least one elliptic curve coefficient of an elliptic curve that is operably utilized in the elliptic curve arithmetic operation 504. Additionally, the elliptic curve computational unit is also operably configured to receive an elliptic curve coefficient randomization numerical input 510 that includes a numerical value that is operably configured for use in the elliptic curve arithmetic operation 504. The elliptic curve computational unit is also operably configured to compute at least one new and substantially equivalent elliptic curve representation for the at least one elliptic curve coefficient of the elliptic curve by performing at least one field operation with the elliptic curve numerical input 508 and the elliptic curve coefficient randomization numerical input 510 and operably configured to utilize the at least one new and substantially equivalent elliptic curve representation in the sequence of field operations 506. The system also includes an arithmetic output port 512 that is operably configured to output at least one numerical result or output(s) 514 from the elliptic curve arithmetic operation 504.

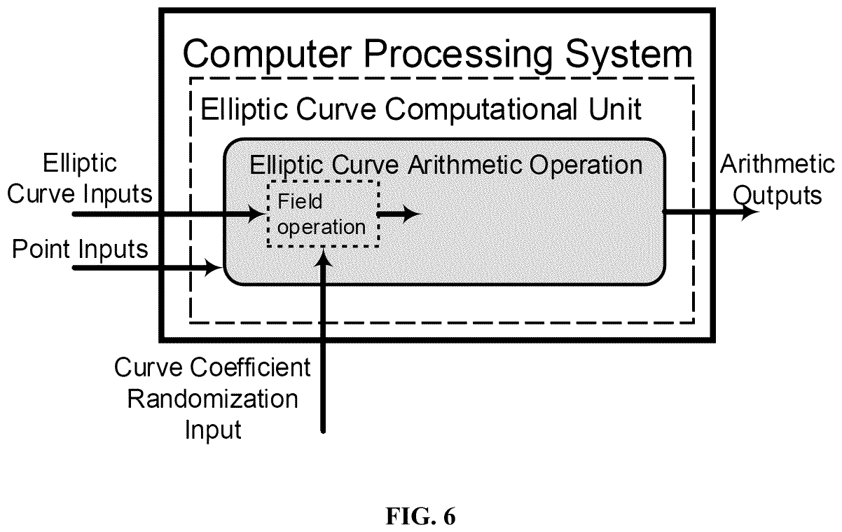

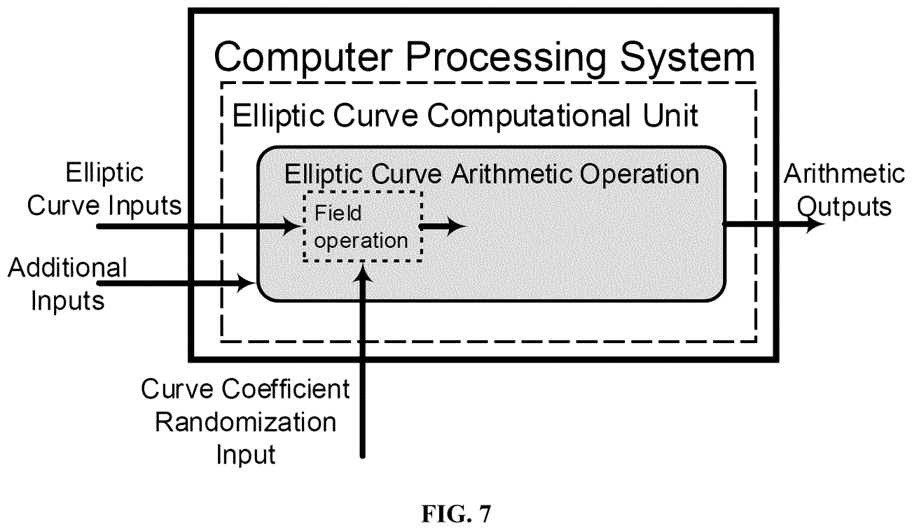

Depending on the elliptic curve operation, there may be an elliptic curve point numerical input that accepts at least one elliptic curve point, which may reside on the elliptic curve received on the elliptic curve numerical input, which is shown in FIG. 6. This elliptic curve point can be represented with a projective coordinate representation where an additional projective point value is introduced and utilized in the elliptic curve arithmetic. Examples of elliptic curve projective point representations include, but are not limited to, short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves. Elliptic curve operations may also require an additional input as is shown in FIG. 7. An example of an additional input could be, but is not limited to, a scalar that could be used in a scalar point multiplication or a non-constant rational map that could be used in an isogeny computation.

The elliptic curve computational unit can perform any number of elliptic curve operations. Some examples of elliptic curve arithmetic operations include point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, and elliptic curve hashing.

An additional embodiment of this invention is to receive the elliptic curve coefficient randomization numerical input from a random number generator or some source that generates a random series of bits from a source with high entropy. Random number generators use a chaotic source such as physical phenomena to generate a bitstream with sufficient randomness. By using a random source for the elliptic curve coefficient randomization numerical input, it becomes significantly harder for an attacker to discover the numerical value that was used to randomize the elliptic curve arithmetic.

Since elliptic curve information is obscured with a random value, this invention applies well to any public-key cryptosystem, including elliptic curve cryptosystems, pairing-based cryptosystems, and isogeny-based cryptosystems.

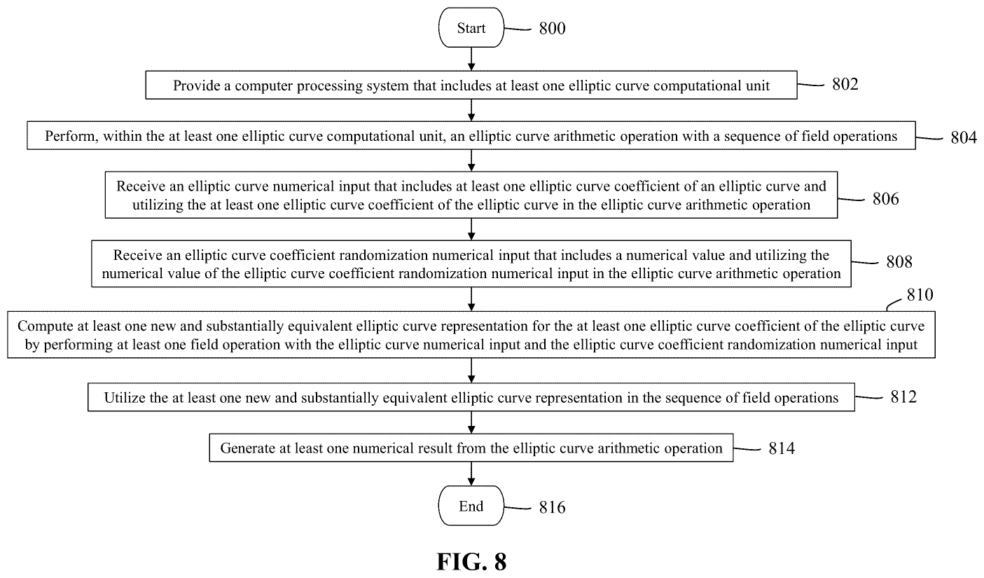

With reference to FIG. 8, a process-flow diagram depicting an exemplary computer-implemented method for adding side-channel attack resistance in elliptic curve arithmetic is depicted. The process may begin at step 800 and immediately proceed to the step of 802 providing a computer processing system that includes at least one elliptic curve computational unit. Next, the process may include the step 804 of performing, within the at least one elliptic curve computational unit, an elliptic curve arithmetic operation with a sequence of field operations.

Thereafter, the process continues to step 806 receiving an elliptic curve numerical input that includes at least one elliptic curve coefficient of an elliptic curve and utilizing the at least one elliptic curve coefficient of the elliptic curve in the elliptic curve arithmetic operation. The elliptic curve numerical input that represents the elliptic curve may be in any of the following forms: Short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves. In one embodiment, the method includes receiving the elliptic curve point numerical input that includes at least one elliptic curve point in the at least one elliptic curve computational unit and utilizing the at least one elliptic curve point in the elliptic curve arithmetic operation. The method may also include utilizing an additional projective point value, as part of the at least one elliptic curve point, in the elliptic curve arithmetic operation. The at least one elliptic curve point may use any of the following coordinates: Projective coordinates, Kummer coordinates, inverted coordinates, extended coordinates, Jacobian coordinates, modified Jacobian coordinates, doubling Doche-Icart-Kohel coordinates, tripling Doche-Icart-Kohel coordinates, extended Hessian coordinates, projective Jacobi quartics coordinates, extended Jacobi quartics coordinates, projective Jacobi intersection coordinates, or extended Jacobi intersection coordinates. Further, the method may include receiving an additional input that includes a scalar or numerical value in the at least one elliptic curve computational unit and utilizing the scalar or numerical value in the elliptic curve arithmetic operation. The method may also include performing, with the elliptic curve computational unit, one or more of the following elliptic curve arithmetic operations: Point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, or elliptic curve hashing.

Next, the process may include step 808 of receiving an elliptic curve coefficient randomization numerical input that includes a numerical value and utilizing the numerical value of the elliptic curve coefficient randomization numerical input in the elliptic curve arithmetic operation. In some embodiments, the process includes randomly generating the elliptic curve coefficient randomization numerical input. The process also includes the step 810 of computing at least one new and substantially equivalent elliptic curve representation for the at least one elliptic curve coefficient of the elliptic curve by performing at least one field operation with the elliptic curve numerical input and the elliptic curve coefficient randomization numerical input.

Thereafter, the process includes step 812 of utilizing the at least one new and substantially equivalent elliptic curve representation in the sequence of field operations and step 814 of generating at least one numerical result from the elliptic curve arithmetic operation. In one embodiment, the process includes utilizing the at least one numerical result from the elliptic curve arithmetic operation in an elliptic curve cryptosystem, a pairing-based cryptosystem, or an isogeny-based cryptosystem and may also include computing the least one new and substantially equivalent elliptic curve representation by performing at least one field multiplication with the curve coefficient randomization numerical input. The process may terminate at step 816.

Although FIG. 8 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 8 for the sake of brevity. In some embodiments, some or all of the process steps included in FIG. 8 can be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A computer processing system comprising:
at least one elliptic curve computational unit in a computer processing device operably configured to:
perform an elliptic curve arithmetic operation with a sequence of field operations;
receive an elliptic curve numerical input that includes at least one elliptic curve coefficient of an elliptic curve that is operably utilized in the elliptic curve arithmetic operation;
receive an elliptic curve coefficient randomization numerical input that includes a numerical value that is operably configured for use in the elliptic curve arithmetic operation;
compute at least one new and substantially equivalent elliptic curve representation for the at least one elliptic curve coefficient of the elliptic curve by performing at least one field operation with the elliptic curve numerical input and the elliptic curve coefficient randomization numerical input; and
utilize the at least one new and substantially equivalent elliptic curve representation in the sequence of field operations; and
an arithmetic output port that is operably configured to output at least one numerical result from the elliptic curve arithmetic operation.

2. The computer processing system according to claim 1, wherein:
the at least one elliptic curve coefficient represents an elliptic curve of any of the following forms: short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves.

3. The computer processing system according to claim 1, wherein:
the at least one elliptic curve computational unit is operably configured to receive an elliptic curve point numerical input that includes at least one elliptic curve point that is operably utilized in the elliptic curve arithmetic operation.

4. The computer processing system according to claim 3, wherein:
the at least one elliptic curve point includes an additional projective point value operably utilized in the elliptic curve arithmetic operation.

5. The computer processing system according to claim 4, wherein:
the at least one elliptic curve point is represented using any of the following coordinates: projective coordinates, Kummer coordinates, inverted coordinates, extended coordinates, Jacobian coordinates, modified Jacobian coordinates, doubling Doche-Icart-Kohel coordinates, tripling Doche-Icart-Kohel coordinates, extended Hessian coordinates, projective Jacobi quartics coordinates, extended Jacobi quartics coordinates, projective Jacobi intersection coordinates, or extended Jacobi intersection coordinates.

6. The computer processing system according to claim 1, wherein:
the at least one elliptic curve computational unit is operably configured to receive an additional input that includes a scalar or numerical value that is operably utilized in the elliptic curve arithmetic operation.

7. The computer processing system according to claim 1, wherein:
the elliptic curve computational unit is operably configured to perform at least one of the following elliptic curve arithmetic operations: point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, or elliptic curve hashing.

8. The computer processing system according to claim 1, further comprising:
a random number generator operably configured to generate the elliptic curve coefficient randomization numerical input.

9. The computer processing system comprising according to claim 1, wherein:
the at least one numerical result from the elliptic curve arithmetic operation and from the arithmetic output port is operably configured for use in an elliptic curve cryptosystem, a pairing-based cryptosystem, or an isogeny-based cryptosystem.

10. The computer processing system according to claim 1, further comprising:
the at least one elliptic curve computational unit is operably configured to compute the least one new and substantially equivalent elliptic curve representation by performing at least one field multiplication with the curve coefficient randomization numerical input.

11. A computer-implemented method for adding side-channel attack resistance in elliptic curve arithmetic comprising the steps of:
providing a computer processing system that includes at least one elliptic curve computational unit:
performing, within the at least one elliptic curve computational unit, an elliptic curve arithmetic operation with a sequence of field operations:
receiving an elliptic curve numerical input that includes at least one elliptic curve coefficient of an elliptic curve and utilizing the at least one elliptic curve coefficient of the elliptic curve in the elliptic curve arithmetic operation;
receiving an elliptic curve coefficient randomization numerical input that includes a numerical value and utilizing the numerical value of the elliptic curve coefficient randomization numerical input in the elliptic curve arithmetic operation;
computing at least one new and substantially equivalent elliptic curve representation for the at least one elliptic curve coefficient of the elliptic curve by performing at least one field operation with the elliptic curve numerical input and the elliptic curve coefficient randomization numerical input;
utilizing the at least one new and substantially equivalent elliptic curve representation in the sequence of field operations; and
generating at least one numerical result from the elliptic curve arithmetic operation.

12. The computer-implemented method according to claim 11, further comprising:
receiving the elliptic curve numerical input that represents an elliptic curve of any of the following forms: short Weierstrass curves, Montgomery curves, Edwards curves, twisted Edwards curves, Hessian curves, twisted Hessian curves, doubling-oriented Doche-Icart-Kohel curves, tripling-oriented Doche-Icart-Kohel curves, Jacobi intersections, Jacobi quartics, binary Edwards curves, binary Hessian curves, or binary short Weierstrass curves.

13. The computer-implemented method according to claim 11, further comprising:
receiving the elliptic curve point numerical input that includes at least one elliptic curve point in the at least one elliptic curve computational unit and utilizing the at least one elliptic curve point in the elliptic curve arithmetic operation.

14. The computer-implemented method according to claim 13, further comprising:
utilizing an additional projective point value, as part of the at least one elliptic curve point, in the elliptic curve arithmetic operation.

15. The computer-implemented method according to claim 14, further comprising:
utilizing the at least one elliptic curve point using any of the following coordinates: projective coordinates, Kummer coordinates, inverted coordinates, extended coordinates, Jacobian coordinates, modified Jacobian coordinates, doubling Doche-Icart-Kohel coordinates, tripling Doche-Icart-Kohel coordinates, extended Hessian coordinates, projective Jacobi quartics coordinates, extended Jacobi quartics coordinates, projective Jacobi intersection coordinates, or extended Jacobi intersection coordinates.

16. The computer-implemented method according to claim 11, further comprising:
receiving an additional input that includes a scalar or numerical value in the at least one elliptic curve computational unit and utilizing the scalar or numerical value in the elliptic curve arithmetic operation.

17. The computer-implemented method according to claim 11, further comprising:
performing, with the elliptic curve computational unit, at least one of the following elliptic curve arithmetic operations: Point addition, point inversion, point subtraction, point doubling, point halving, scalar point multiplication, point counting, cardinality computations, finding generator points, finding a random point, calculating point order, checking supersingularity, Frobenius endomorphisms, j-invariant computation, elliptic curve isomorphism, elliptic curve isogeny, elliptic curve pairing, or elliptic curve hashing.

18. The computer-implemented method according to claim 11, further comprising:
randomly generating the elliptic curve coefficient randomization numerical input.

19. The computer-implemented method according to claim 11, further comprising:
utilizing the at least one numerical result from the elliptic curve arithmetic operation in an elliptic curve cryptosystem, a pairing-based cryptosystem, or an isogeny-based cryptosystem.

20. The computer-implemented method according to claim 11, further comprising:
computing the least one new and substantially equivalent elliptic curve representation by performing at least one field multiplication with the curve coefficient randomization numerical input.
